(19) United States
(12) Patent Application Publication
(10) Pub. No.: US 2004/0080826 A1
(43) Pub. Date: Apr. 29, 2004

(54) Optical low pass filter

(75) Inventor: Masato Noguchi, Saitama-ken (JP)

Correspondence Address: GREENBLUM & BERNSTEIN, P.L.C., 1950 ROLAND CLARKE PLACE, RESTON, VA, 20191, US

(73) Assignee: PENTAX Corporation, Tokyo (JP)

(21) Appl. No.: 10/676,119

(22) Filed: Oct. 2, 2003

(30) Foreign Application Priority Data
Oct. 4, 2002 (JP) 2002-292893

(51) Int. Cl. G02B 5/30; G02B 27/28

(52) U.S. Cl. 359/494

(57) ABSTRACT

An optical low pass filter includes a first birefringence plate that divides an incident ray into two rays, and a second birefringence plate that divides an incident ray into two rays. The first birefringence plate and the second birefringence plate are cemented with each other. Light passed through the first birefringence plate passes through the second birefringence plate. The first birefringence plate and the second birefringence plate are arranged such that a separation angle θs representing a difference between the direction in which the first birefringence plate divides the incident ray and the second direction in which the second birefringence plate divides the incident ray satisfies a condition below:

45°<θs<90°.

### BACKGROUND OF THE INVENTION

The present invention relates to an optical low pass filter (OLPF) and an imaging optical system employing the OLPF.

Recently, digital cameras have been widespread. For digital cameras employing solid-state imaging elements such as a CCD (Charge Coupled Device), it is important to avoid a moiré effect.

For this purpose, an optical low pass filter (OLPF) is generally provided between the photographing lens and the imaging surface so that the high spatial frequency components are removed from the image formed on the imaging surface.

A conventional OLPF is configured to have three cemented birefringence plates (which will be referred to as a three-element OLPF), or two birefringence plates with a predetermined wavelength plate sandwiched therebetween. Such a conventional OLPF divides a single incident beam into four beams by dividing the incident beam into two beams in a horizontal (or vertical) direction, and then further divides ach of the divided beams into two beams in a vertical (or horizontal) direction so that a point of an image is divided into four points, corresponding to apexes of a square, on the imaging surface. Therefore, when an image is to be formed on the imaging element through the OLPF, a blur effect is applied to the image, thereby the moiré effect can be suppressed or removed. The distance between the four points depends on the thickness of the OLPF.

Generally, the imaging element, or the CCD is formed to have a rectangular shape, and a plurality of pixels are arranged at regular interval, in a matrix, along longer and shorter sides of the rectangular shape. In this specification, the term “horizontal direction” refers to a direction corresponding to the longer side of the rectangular imaging element (e.g., CCD). and the “vertical direction” refers to a direction corresponding to the shorter side of the imaging element.

In the conventional three-element OLPF, when the light incident thereon is not polarized in a specific direction, such as natural light, a ray of light incident on the OLPF is divided such that the intensities of the four spots formed by the four divided rays are the same. In such a condition, the high spatial frequency components can be eliminated substantially equally in the horizontal and vertical directions.

This will be described in detail with reference to FIG. 10.

FIG. 10 is an MTF (Modulation Transfer Function) map illustrating an effect of the three-element OLPF. In FIG. 10, the horizontal axis and vertical axis indicate normalized values of spatial frequencies (where, the frequencies are normalized with respect to an inverse number of a point image dividing amount of the birefringent plate). Specifically, the vertical axis represents the spatial frequencies in the horizontal direction, and the horizontal axis represents the spatial frequency in the vertical direction. In FIG. 10, a region A transmits light with a highest transmittance (MTF value: 0.8-1), a region B has a second highest transmittance (MTF value: 0.6-0.8), a region C has a third highest transmittance (MTF value: 0.4-0.6), and a region D has a fourth highest transmittance (MTF value 0.2-0.4). A region E hardly transmits light (MTF value: 0.0-0.2). Note that the definition of the regions A-E applies in all the MTF maps in this specification.

As shown in FIG. 10, the three-element OLPF has a characteristic in that the region E in the MTF map shown in FIG. 10 has a relatively wide area, and suppresses components having a spatial frequency (normalized) of −0.4 or less, or +0.4 or more. The function of suppressing/eliminating the high spatial frequency components provided by the OLPF will be referred to as a cut-off function.

In the conventional OLPF having a characteristic shown in FIG. 10, each of the regions A-D, which allows light incident thereon to transmit, is formed substantially symmetrically either in the vertical direction and horizontal directions. With this configuration, the high spatial frequency components can be eliminated either in the vertical direction or in the horizontal direction in a similar manner. The way the transmitting regions (i.e., the regions A-D) expand will be referred to as a cut-off directionality. The conventional OLPF having the characteristic shown in FIG. 10 has a excellent cut-off directionality such that the performance thereof has little direction dependency.

Using the three-element OLPF as described above, the high spatial frequency components can be suppressed effectively. However, the birefringence plate and/or wavelength plate are relatively expensive, and therefore, to employ the three-element OLPF increases a manufacturing cost.

In order to reduce the manufacturing cost, a two-element OLPF consisting of two birefringence plates has been suggested recently. An example of the two-element OLPF is disclosed in Japanese Patent No. 2507041.

The two-element OLPF disclosed in the above patent is configured such that a ray of light incident on the OLPF is firstly divided in the horizontal direction (or in a direction inclined from the horizontal direction by 45 degrees), and then each of the two rays is divided in a direction inclined with respect to the horizontal direction by 45 degrees (or, in the horizontal direction). Accordingly, the four spots formed by the four divided rays are arranged on apexes of the parallelogram. It should be noted that the inclined angle is 45 degrees since the intensities of the four spots on the imagines surface are substantially the same when the OPLF is constructed as above.

FIG. 11 shows the MTF map of such a two-element OLPF. As shown in FIG. 11, when the two-element OLPF is used, the region E has a relatively wide area, and thus the cut-off performance is sufficiently high. However, the cut-off directionality is worse. That is, the regions A-D expand greater in one direction (direction PL in FIG. 11) than another direction (direction PS) which is perpendicular to the direction PL. When this OLPF is used, the degree of blur in the PL direction is smaller than the degree of blur in the PS direction.

As above, when the two-element OLPF is employed, although the high cut-off performance is expected, due to the lopsided cut-off directionality, the quality of the captured image is lowered since the resolution of the captured image differs depending on the direction.

In the following description, when the MTF maps are referred to, the direction in which each region (A, B, C and D) expands greatest is indicated as direction PL, and the direction in which each region expands smallest is indicated as the PS direction.

### SUMMARY OF THE INVENTION

The present invention is advantageous in that an improved imaging optical system is provided, in which a two-element OLPF is employed but sufficiently high cut-off directionality is achieved.

According to an aspect of the invention, there is provided an optical low pass filter, which includes a first birefringence plate that divides an incident ray into two rays, and a second birefringence plate that divides an incident ray into two rays. The first birefringence plate and the second birefringence plate are cemented with each other. Light passed through the first birefringence plate passes through the second birefringence plate. The first birefringence plate and the second birefringence plate are arranged such that a separation angle θs representing a difference between the direction in which the first birefringence plate divides the incident ray and the second direction in which the second birefringence plate divides the incident ray satisfies a condition below:

45°<θs<90°.

Optionally, the separation angle θs satisfies a following condition:

50°<θs<60°.

According to another aspect of the invention, there is provided an imaging optical system, which is provided with an image capturing element having a plurality of pixels regularly and two-dimensionally arranged in a horizontal direction and in a vertical direction, a photographing lens forming an image on the image capturing element, and an optical low pass filter as described above. The optical low pass filter is arranged to be rotated with respect to the image capturing element.

Optionally, the separation angle θs is defined by a following equation:

θs=|θ1−74 2|.

where θ1 is an angle in which the first birefringence plate divides the incident beam with respect to the horizontal direction, before the optical low pass filter is rotated, and θ2 is an angle in which the second birefringence plate divides the incident beam with respect to the horizontal direction, before the optical low pass filter is rotated.

### BRIEF DESCRIPTION OF THE DRAWINGS

FIG. 1 is a diagram schematically shows a structure of an imaging optical system according to an embodiment of the invention;

FIG. 2 is a graph showing characteristics of a cut-off performance (solid line) and a directionality (broken line) of the cut-off performance with respect to a separation angle;

FIG. 3 shows an MTF map when the separation angle is 50.77°;

FIG. 4 shows an MTF map when the separation angle is 54.74°;

FIG. 5 shows an MTF map when the separation angle is 60°;

FIG. 6 shows an MTF map of a design example of the OLPF according to the invention;

FIG. 7 shows an MTF map of a design example of the conventional three-element OLPF;

FIG. 8 shows an MTF map of the conventional two-element OLPF of which the separation angle is set to 45°;

FIG. 9 is an MTF map of the OLPF according to a modification of the embodiment;

FIG. 10 is an MTF map of the conventional three-element OLPF; and

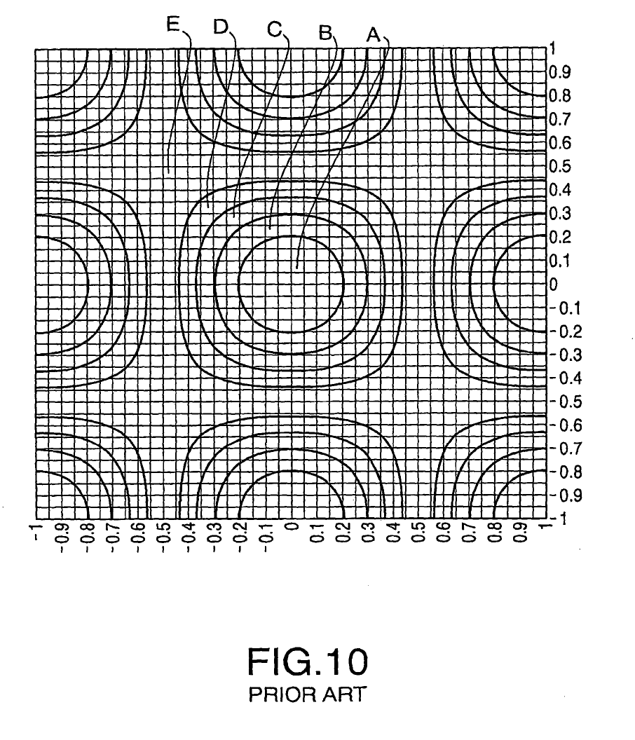

FIG. 11 is a MTF map of the conventional two-element OLPF.

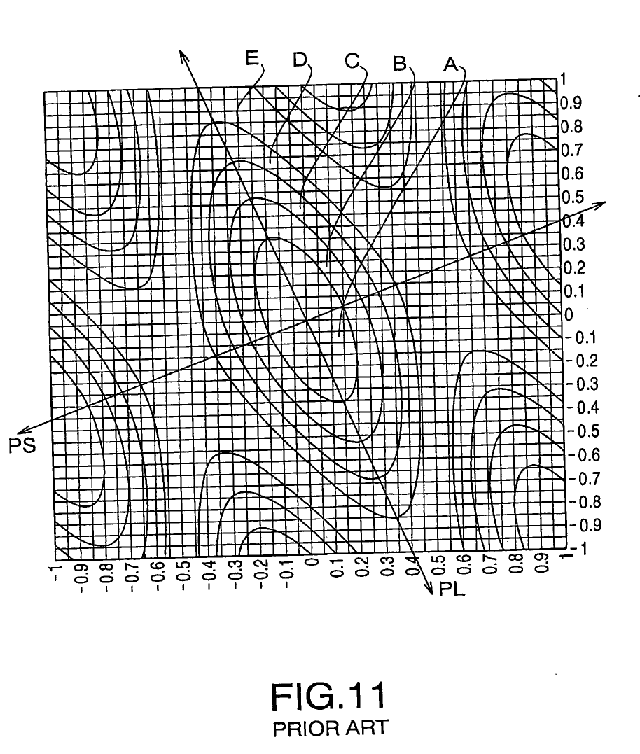

### DETAILED DESCRIPTION OF THE EMBODIMENT

Hereinafter, referring to the accompanying drawings, an imaging optical system according to an embodiment of the invention will be described.

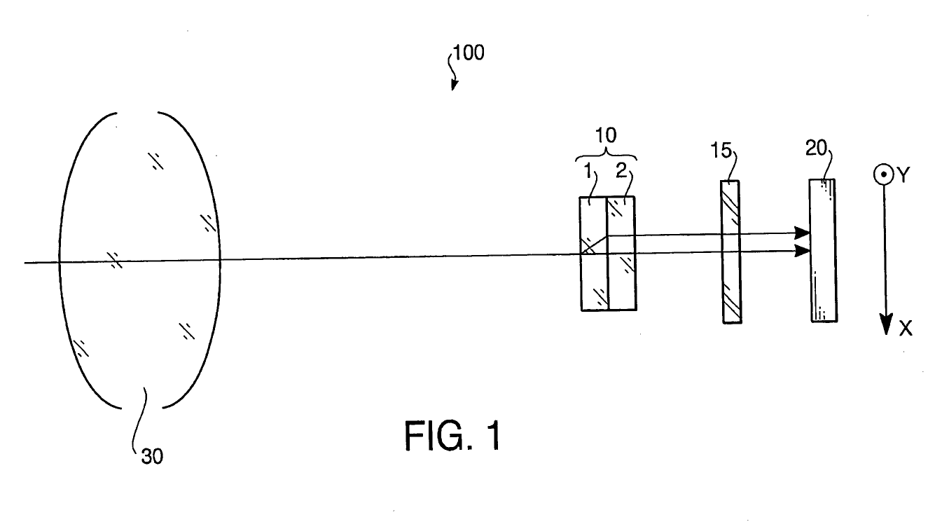

FIG. 1 is a diagram schematically showing a configuration of an imaging optical system 100 according to an embodiment of the invention.

The imaging optical system 100 is used, for example, as imaging optical system of a single lens reflex digital camera.

The imaging optical system 100 includes, in the order from an object side, a photographing lens group 30, an OLPF 10 and a CCD 20. The OLPF 10 has, from the object side, a first birefringence plate 1 and a second birefringence plate 2 cemented with each other. The CCD 20 has a plurality of pixels regularly arranged in the horizontal direction (X direction in FIG. 1) and in the vertical direction (Y direction in FIG. 1).

As shown in FIG. 1, each light ray (only one ray is indicated in FIG. 1) from the object (not shown) located on a left-hand side of FIG. 1 transmits the photographing lens group 30 and is incident on the OLPF 10. The OLPF 10 divides each light ray incident thereon into four rays (in FIG. 1, each two rays are overlapped). The four rays are then passed through an IR cut filter 15 and incident on four points of the CCD 20, respectively.

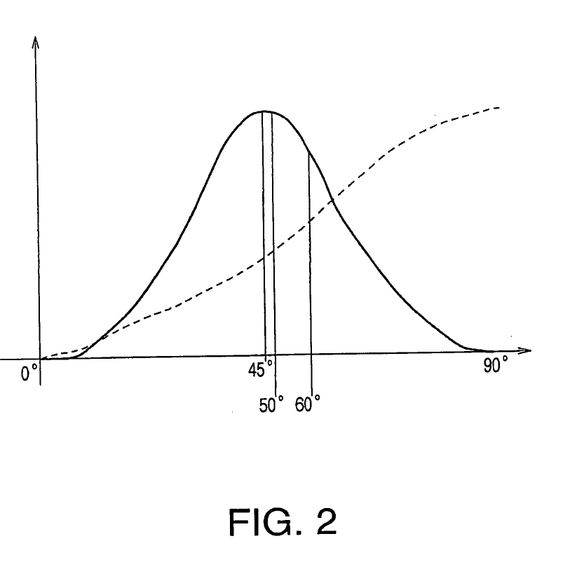

FIG. 2 is a graph showing characteristics of a cut-off performance (solid line), and a directionality (broken line) of the cut-off performance with respect to a separation angle θs. In this specification, the separation angle θs represents an angle formed between a separated direction (θ1), with respect to the horizontal direction (i.e., X direction), of a ray incident on the first birefringence plate and a separated direction (θ2), with respect to the horizontal direction (i.e., X direction), of a ray incident on the second birefringence plate. Thus, the separation angle is expressed as:

θs=|θ1−θ2|.

As shown in FIG. 2, the cut-off performance of the OLPF 10 increases when the separation angle θs is increased from 0°, and has the greatest value when θs is 45°. The cut-off performance is lowered as the separation angle θs is further increased from 45°. The cut-off directionality of the OLPF 10 is increased as the separation angle θs is increased.

As described above, the conventional two-element OLPF is configured such that the separation angle θs is 45° since the cut-off performance is greatest at this angle. However, as pointed out above, when the separation angle θs is 45°, the cut-off directionality is not sufficiently high, and accordingly, the quality of the image is worsened.

It is understood from FIG. 2 that in order to improve the directionality of the OLPF 10, it is necessary to set the separation angle θs to a value greater than 45°. That is, the separation angle should satisfy a condition:

45°<θs<90° (1)

If the separation angle θs is smaller than the lower limit of condition (1), both the cut-off performance and the cut-off directionality are worsened, which is not preferable. If the separation angle θs is 90°, two of the four rays emerged from the OLPF 10 have the intensity of zero. That is, the OLPF 10 only functions in one direction, and does not exhibit a two-dimensional cut-off function.

Further, as shown in FIG. 2, the cut-off performance is maintained at a higher level even after the separation angle θs exceeds 45°. In view of this, in order to realize a totally high performance OLPF, it is preferable that the separation angle θs satisfies the following condition.

50°≦θs≦60° (2)

Within this range of the separation angle θs, the cut-off performance decreases but still has a higher value, and the cut-off directionality increases and has a sufficiently higher value.

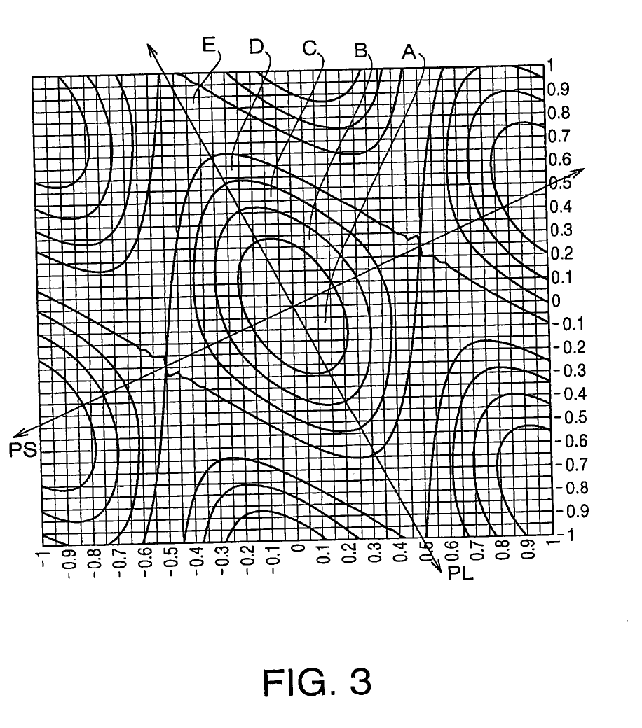

Hereinafter, referring to FIGS. 3-5, three examples of the OLPF 10 which are designed to satisfy condition (2) will be described.

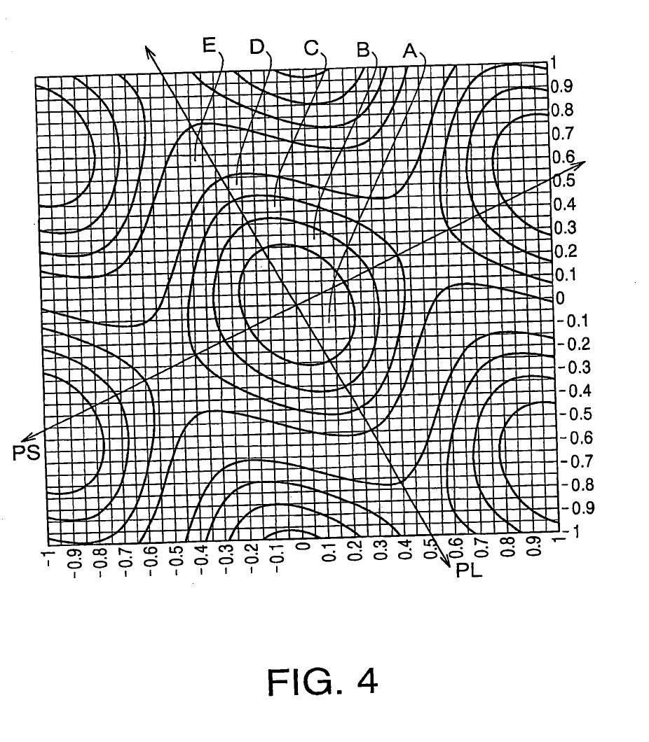

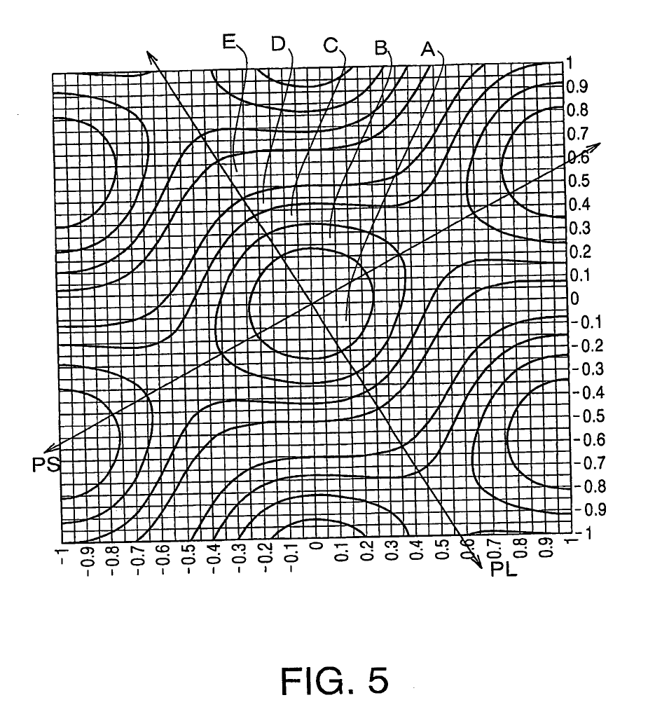

FIG. 3 shows an MTF map of a first example which is designed such that the separation angle is 50.77°, FIG. 4 shows an MTF map of a second example designed such that the separation angle is 54.74°, and FIG. 5 shows an MTF map of a third example designed such that the separation angle is 60°.

It is understood from FIGS. 3-5 that, as the separation angle θs becomes greater, a difference between the area of the regions A-D in the direction PL and the area in the direction PS becomes smaller. That is, the directionality is better for the greater separation angle θs. However, as the separation angle θs increases, the area of the region E becomes smaller. Thus, for the greater separation angle, the cut-off performance becomes lower.

In view of the above, the separation angle θs should be determined so that the quality of the image is maximized taking the spatial frequency components of light incident on the imaging optical system 100 and the performance of the photographing lens group 30 into account. Thus, the separation angle may be determined in accordance with a sensuous evaluation of the formed image (i.e., may be determined so as to provide a sensuously satisfactory result).

Next, the performance of the OLPF 10 satisfying condition (2) will be described in detail. It should be noted that, in the second example (see FIG. 4), the cut-off performance and the directionality are well balanced, and thus the second example is described in detail.

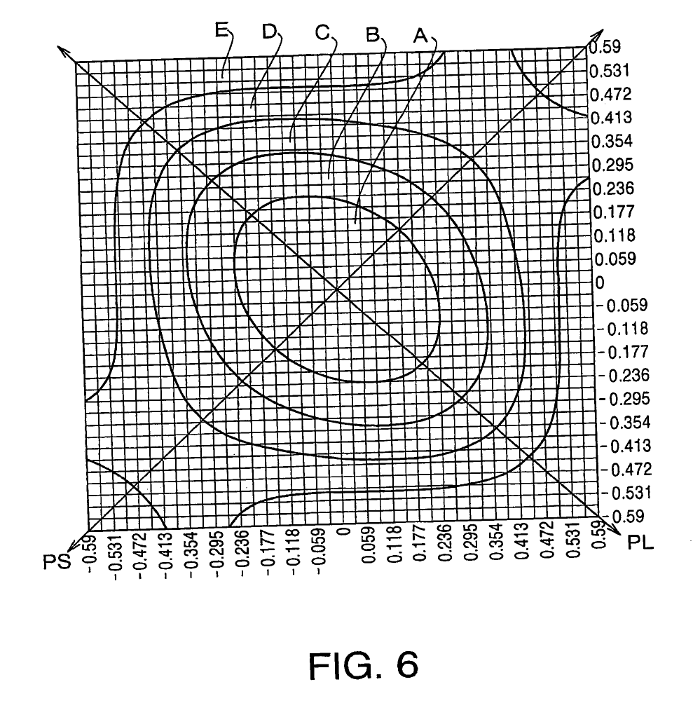

FIG. 6 shows an MTF map of a design example of the OLPF based on the second example, whose separation angle θs is 50.74°. As is understood by comparing FIGS. 4 and 6, FIG. 6 shows an enlarged part of the MTF map shown in FIG. 4 and the OLPF 10 is rotated such that the directions PS and PL coincides with diagonal lines of the MTF map.

Generally, human eyes tend to recognize horizontally or vertically extending objects, which provide high spatial frequency components of an image, as noise components, and in such a case, the image is considered to have low quality. In order to eliminate, substantially evenly, the high spatial frequency components extending in the vertical and horizontal directions, the OLPF 10 having the separation angle θs of 54.74° is rotated with respect to the CCD 20 so that the directions PL and PS coincide with the diagonal lines of a pixel of the CCD. With this arrangement, the degrees of blur of the image in the horizontal and vertical directions can be made substantially evenly.

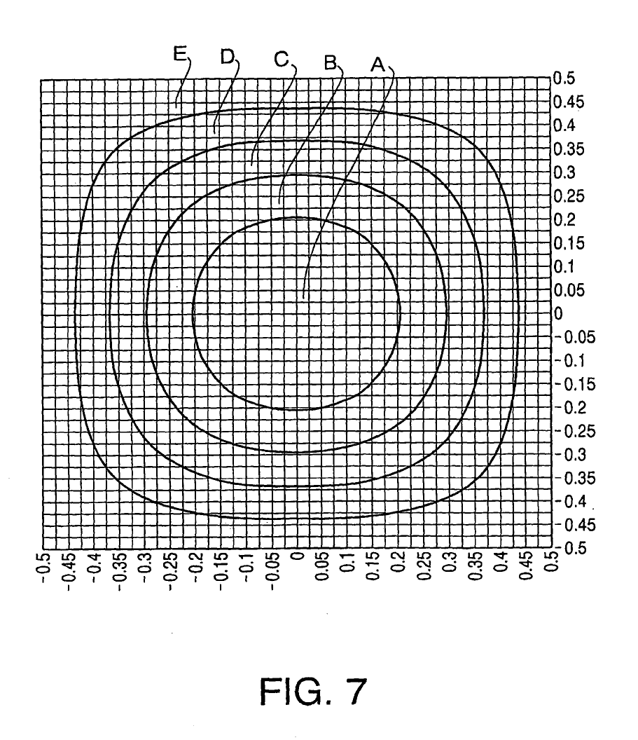

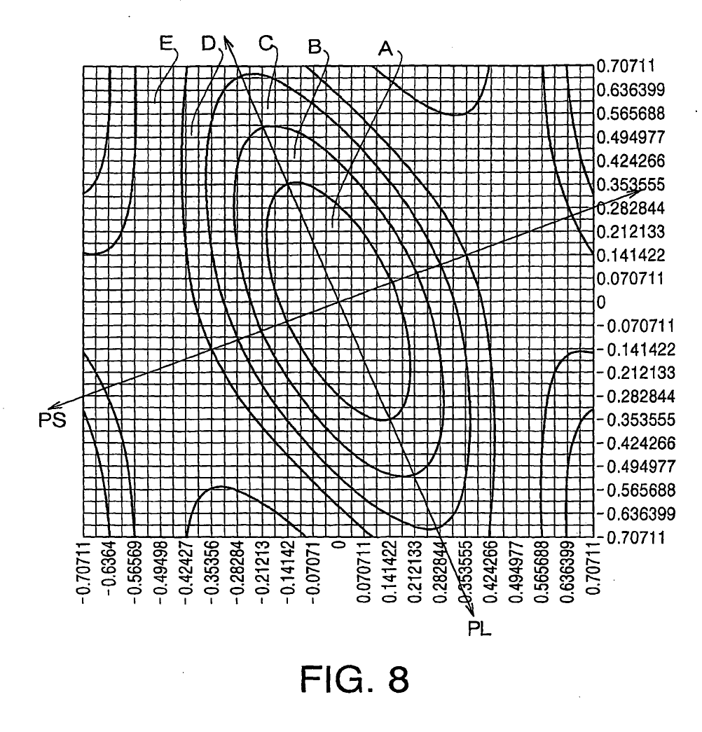

FIG. 7 shows an MTF map of a design example using the conventional three-element OLPF. FIG. 8 shows an MTF map of the conventional two-element OLPF of which the separation angle θs is set to 45°

The following is understood by comparing FIG. 6 with FIGS. 7 and 8. The size of the region E of the OLPF 10 shown in FIG. 6 (θs=54.77°) is smaller than the size of the region E shown in FIG. 8, but substantially the same size as the region E shown in FIG. 7. Further, the shapes of the regions A-D of the OLPF 10 shown in FIG. 6 are closer to the shapes of the regions A-D shown in FIG. 7 than those shown in FIG. 8 (i.e., closer to a circular or rounded square shape). Therefore, the OLPF 10, which is a two-element OLPF and has the separation angle θs of 54.74° has the cut-off performance and the directionality closer to those of the conventional three-element OLPF than the conventional two-element OLPF. Accordingly, the OLPF 10 can eliminate the high spatial frequency components effectively although it is configured as a two-element OLPF.

In the above-described examples, the lengths of a pixel in the horizontal and vertical directions are the same. Corresponding to this structure, the thickness of the first birefringence plate and the thickness of the second birefringence plate are the same. The ratio of the thickness of the first birefringence plate to the length of the second birefringence plate is determined in accordance with the ratio of the horizontal length to the vertical length of a pixel of the CCD 20. Recently, a CCD having a rectangular pixel (having different lengths in the vertical and horizontal directions) has been used mainly in the digital video camera. When used with such a CCD, the OLPF is configured such that the thicknesses of the first and second birefringence plates are determined in accordance with the lengths of the pixel of the CCD.

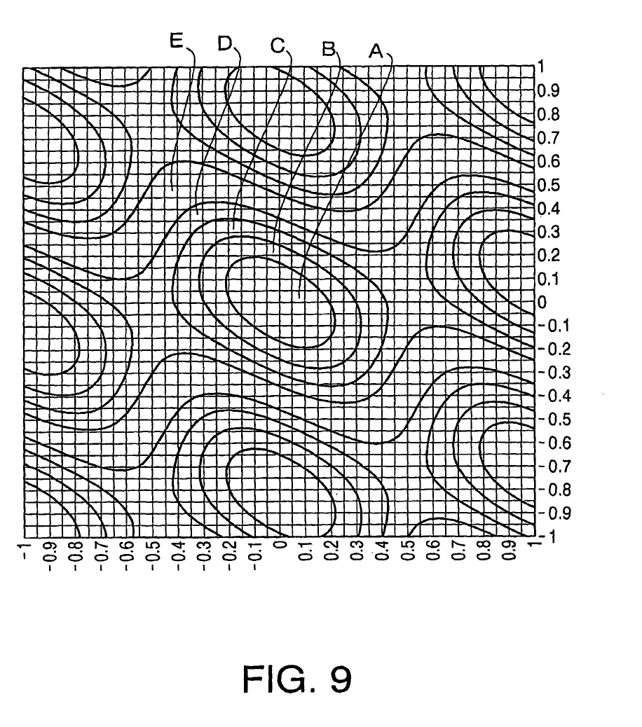

FIG. 9 is an MTF map of the OLPF which is configured such that the ratio of the thickness of the first birefringence plate to the thickness of the second birefringence plate is 1:1.5, the separation angle θs being 54.74°. As shown in FIG. 9, by varying the ratio of the thickness of the first birefringence plate to the thickness of the second birefringence plate, respectively, the shapes of the regions A-D can be changed to meet the pixel having the different horizontal and vertical lengths.

The present disclosure relates to the subject matter contained in Japanese Patent Application No. 2002-292893, filed on Oct. 4, 2002, which is expressly incorporated herein by reference in its entirety.

What is claimed is:

1. An optical low pass filter, comprising:
a first birefringence plate that divides an incident ray into two rays; and
a second birefringence plate that divides an incident ray into two rays,
said first birefringence plate and said second birefringence plate being cemented, light passed through said first birefringence plate passing through said second birefringence plate, said first birefringence plate and said second birefringence plate being arranged such that a separation angle θs representing a difference between the direction in which said first birefringence plate divides the incident ray and the second direction in which said second birefringence plate divides the incident ray satisfies a condition below:
45°<θs<90°.

2. The optical low pass filter according to claim 1, wherein the separation angle θs satisfies a following condition:
50°<θs<60°.

3. An imaging optical system, comprising:
an image capturing element having a plurality of pixels regularly and two-dimensionally arranged in a horizontal direction and in a vertical direction;
a photographing lens forming an image on said image capturing element; and
an optical low pass filter including a first birefringence plate that divides an incident ray into two rays and a second birefringence plate that divides an incident ray into two rays, said first birefringence plate and said second birefringence plate being cemented, light passed through said first birefringence plate passing through said second birefringence plate, said first birefringence plate and said second birefringence plate being arranged such that a separation angle θs representing a difference between the direction in which said first birefringence plate divides the incident ray and the second direction in which said second birefringence plate divides the incident ray satisfies a condition below:
45°<θs<90°,
said low pass filter being arranged to be rotated with respect to the horizontal direction by a predetermined angle Δθ.

4. The imaging optical system according to claim 3, wherein the separation angle θs satisfies a following condition:
50°<θs<60°.

5. The imaging optical system according to claim 3, wherein the separation angle θs is defined by a following equation:
θs=|1−74 2|.
θ1 being an angle in which said first birefringence plate divides the incident beam with respect to the horizontal direction, before said optical low pass filter is rotated, and
θ2 being an angle in which said second birefringence plate divides the incident beam with respect to the horizontal direction, before said optical low pass filter is rotated.
